(19) United States
(12) Patent Application Publication
(10) Pub. No.: US 2006/0191487 A1
(43) Pub. Date: Aug. 31, 2006

(54) Animal feeding assembly

(76) Inventor: Jane Grant, Londonderry (GB)

Correspondence Address: NATH & ASSOCIATES, 112 South West Street, Alexandria, VA, 22314, US

(21) Appl. No.: 11/065,286

(22) Filed: Feb. 25, 2005

(51) Int. Cl. A01K 5/01

(52) U.S. Cl. 119/61.54

(57) ABSTRACT

The present invention provides an animal feeding assembly which includes a food receptacle in the form of a bowl, and a support adapted to hold the bowl at an orientation in which a mouth of the bowl is tilted such as to be disposed at an acute angle to a surface on which, in use, an animal stands while feeding from the bowl, in order to improve access to the bowl.

The present invention is concerned with an animal feeding assembly, and in particular a feeding assembly which greatly simplifies the feeding process for an animal such as a dog or cat, in addition to aiding in the digestive process.

Animals such as dogs and cats are a large part of peoples lives in almost every country in the world, and for people from all walks of life. Pet owners take great pride in their animals, and one of the most obvious indications of this is the huge variety of pet foods available, catering for pets at various stages in their life, or including nutrients/supplements for various reasons, not to mention the variety of flavours that, in particular, dog and cat food are available in. This selection of pet foods reflects the high demands that pet owners have with respect to the food, and therefore nutrition, that their pets receive.

However, despite all of the time, effort and expense that is channelled into producing all the varieties of pet foods, the art of actually feeding such foods to a pet has largely been ignored, but is an area that is of significant importance. This is particularly true when it is considered that, at least in the case of dogs and cats, the animal does not have any hands with which to assist in feeding itself, and thus must simply lower their head into a food bowl to feed. This process presents a number of difficulties, not least the tendency for the animals bowl to slowly migrate away from the pet during feeding, thus resulting in the often comical sight of an animal essentially chasing their bowl across the floor while feeding, which it will be appreciated is frustrating for the animal involved.

The present invention has therefore been developed with a view to mitigating a number of the problems inherent in conventional pet food bowls.

The present invention has also been developed with a view to providing a hygienic and functional feeding assembly which is beneficial to both animal and owner.

The present invention therefore provides an animal feeding assembly comprising a food receptacle; and a support adapted to hold the receptacle at an orientation in which a mouth of the receptacle is disposed at an acute angle to a surface on which, in use, an animal is positioned while feeding from the receptacle.

Preferably, the receptacle has at least a curved base to prevent food from lodging in the receptacle.

Preferably, the mouth is disposed at an angle of between 1° and 60°, more preferably between 20° and 40°, and most preferably 32.5°.

Preferably, the receptacle is releasably securable to the support.

Preferably, the receptacle is substantially hemispherical in shape.

Preferably, the support is adapted to hold a pair of the receptacles.

Preferably, the support comprises at least one ground contacting foot.

Preferably, the support comprises a pair of ground contacting feet in spaced relation to each other.

Preferably, at least one of the ground contacting feet is located, in use, upstream of the receptacle with respect to an animal feeding from the receptacle.

Preferably, the or each foot comprises a non slip surface.

Preferably, the support defines at least one opening for receiving the at least one receptacle.

Preferably, the receptacle comprises a circumferentially disposed rim about the mouth.

Preferably, the receptacle comprises at least one tab projecting from the mouth.

Preferably, the support comprises a first portion adapted to enable the assembly to be mounted to a substantially upright surface such as a wall or the like.

Preferably, the receptacle has at least a curved base to prevent food from lodging in the receptacle.

Preferably, the mouth is disposed, in use, at an angle of between 1° and 60°, more preferably between 20° and 40°, and most preferably 32.5°.

Preferably, the receptacle is releasably securable to the support.

Preferably, the receptacle is substantially hemispherical in shape.

Preferably, the support is adapted to hold a pair of the receptacles.

Preferably, the support comprises a second portion extending from the first portion, to which second portion the at least one receptacle is securable.

Preferably, the support comprises a coupling in operative association with the first portion for securing the support to a surface, which coupling is adapted to enable, in use, relative displacement between the coupling and the support.

Preferably, the support defines at least one opening for receiving the at least one receptacle.

Preferably, the receptacle comprises a circumferentially disposed rim about the mouth.

Preferably, the receptacle comprises at least one tab projecting from the mouth.

As used herein, the term “receptacle” is intended to mean any vessel or the like, in particular a bowl, which is suitable for receiving pet food, and optionally liquid such as water or milk, for feeding to a pet or other animal.

As used herein, the term “surface” is intended to mean a floor or other area on which a pet stands while feeding from the assembly of the present invention.

As used herein the term “foot” is intended to mean a tab or outcrop of material which, in use, is located against the above mentioned surface, and onto which pressure may be applied in order to prevent slippage between the foot and the surface.

The present invention will now be described with reference to the accompanying drawings, in which;

FIG. 1 illustrates a perspective view of a first embodiment of a feeding assembly according to the present invention;

FIG. 2 illustrates a perspective view of a bowl forming part of the assembly of FIG. 1;

FIG. 3 illustrates a perspective view of a support which, together with the bowl illustrated in FIG. 2, forms the assembly illustrated in FIG. 1;

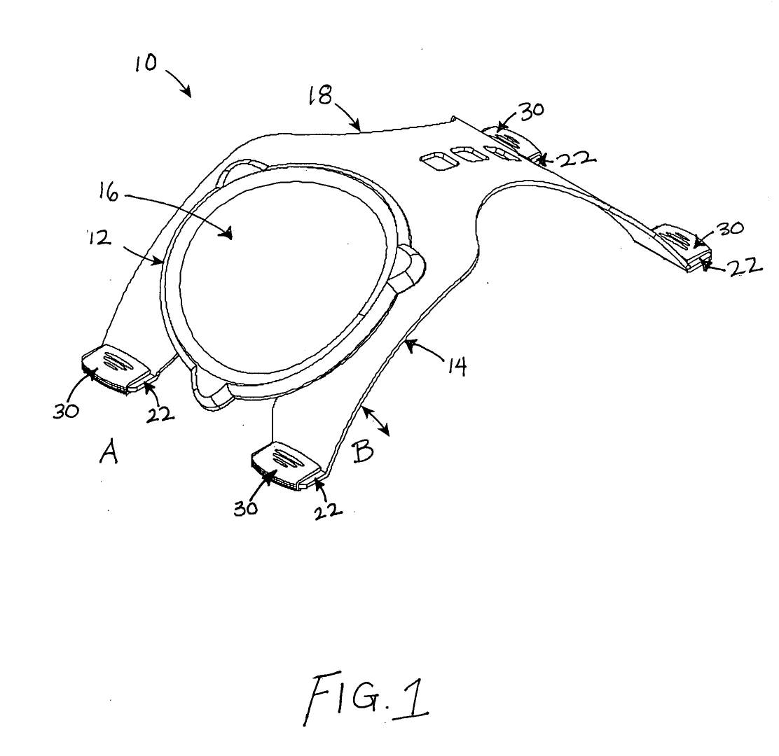

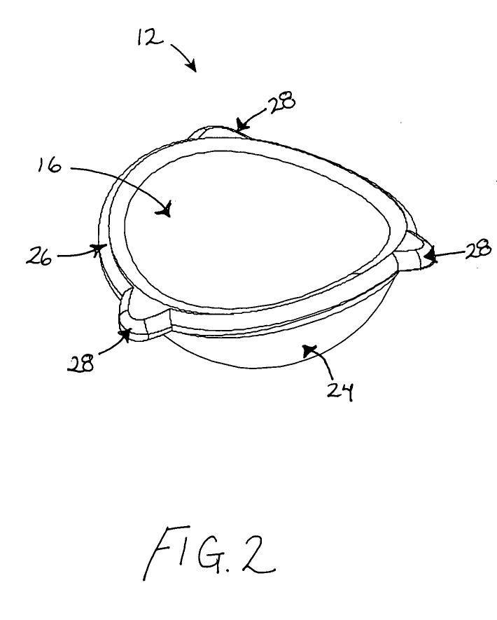

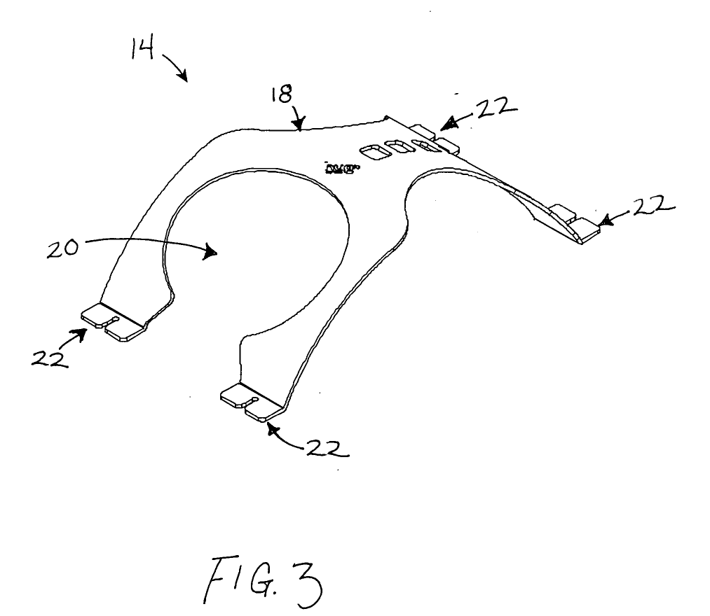

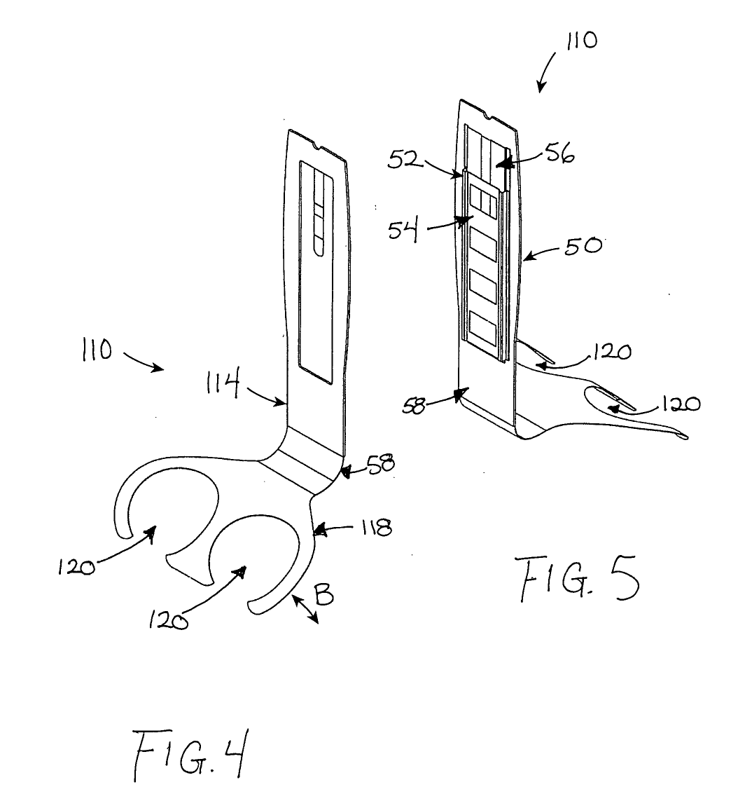

FIG. 4 illustrates a perspective view of a second embodiment of a feeding assembly according to the present invention, in which a pair of bowls forming part of the assembly have been omitted for clarity;

FIG. 5 illustrates a perspective view, from behind, of the feeding assembly illustrated in FIG. 4.

Referring now to FIGS. 1 to 3 of the accompanying drawings, there is illustrated a first embodiment of a feeding assembly, generally indicated as 10, for receiving solid and/or liquid food for feeding to a pet (not shown) or any other animal. The assembly 10 comprises a receptacle in the form of a bowl 12, in addition to a support 14 which is adapted to carry or support the bowl 12, as will be described in detail hereinafter. The primary function of the support 14 is to secure the bowl 12 in a particular orientation during use, such that a mouth 16 of the bowl 12 is tilted or angled forward with respect to a pet or other animal which in use would be feeding from a position roughly indicated as A on FIG. 1 of the accompanying drawings, and hereinafter referred to as being upstream of the assembly 10. Once this functionality is retained, the shape/orientation of the support 14 and the bowl 12 may be varied significantly.

In the embodiment illustrated, the support 14 is comprised of a frame 18 which may be formed from any suitable material, for example sheet metal or the like, and could for example be punched out of a sheet of material, and then bent to the shape illustrated. Alternatively the frame 18 could be moulded from a polymer or the like. The frame 18 defines an opening 20 on the upstream side of the frame 18, which is shaped and dimensioned to receive the bowl 12. The support 14 also comprises four feet 22, one foot 22 extending outwardly from the frame 18 at each corner thereof. It will however be appreciated from the following description that it is the pair of feet 22 adjacent the opening 20 which are particularly advantageous, and the remaining two feet 22 could be omitted.

Thus in use the bowl 12 is located on the support 14, and is at an inclined orientation with respect to a pet located at position A, or in other words when feeding from the bowl 12. In the embodiment illustrated, the assembly 10 is adapted to be free standing on a surface such as a floor or the like, from where a pet can feed from the bowl 12. For the purposes of the following description, the angle of inclination of the bowl 12 is described with reference to the surface (not shown) on which the assembly 10 stands. This angle of inclination, illustrated as B on FIG. 1 of the accompanying drawings, is the acute angle that the mouth 16 of the receptacle 12 makes with the surface (not shown) on which the assembly 10 stands. The inclination of the bowl 12 significantly improves access to the interior of the bowl 12, thereby simplifying access for a pet to food contained within the bowl 12. In addition, as that portion of the mouth 16 which will, during feeding, be closest to the animals neck, and therefore any collar worn, is lower than would normally be the case due to the tilt of the bowl 12, contact between any tags/buckles on the collar, or the collar itself, will be reduced or eliminated, thereby reducing or eliminating the noise created by such contact. While these benefits are achieved for any angle B between 1° and 60°, it has been found that the preferred angle of tilt for the bowl 12 relative to the surface on which the assembly 10 is located, is approximately 32.5°.

It should therefore be realised that the shape and configuration of the support 14 could be significantly altered, while still providing the requisite angle of inclination to the bowl 12. For example, the support 14 could be replaced with a solid wedged-shaped block (not shown), having a recess in the incline upper surface thereof (not shown) for receiving and retaining the bowl 12 therein. Alternatively, such a wedged-shaped block (not shown) could simply be provided with a recess such as a hemispherical recess extending into the block from the inclined upper surface thereof. The block itself would therefore define a receptacle or bowl (not shown) formed integrally therewith.

To compliment the benefits obtained from the angled or inclined orientation of the mouth 16 of the bowl 12, a base 24 of the bowl 12 is preferably concave in form, and in the preferred embodiment illustrated the entire bowl 12 is substantially hemispherical in shape, thereby providing the desired curvature to the base 24 thereof. This curved or concave form prevents any food from becoming trapped or lodged in the bowl 12, as there are no corners or the like in which food can become trapped. Again this feature simplifies the feeding process, allowing a pet to consume all of the food contained within the bowl 12, and thereby avoiding frustration which may otherwise be experienced when food becomes trapped and cannot therefore be consumed, despite being visible to the animal. In addition, if food becomes trapped in a pets bowl (not shown), and remains there for any significant period, it can give rise to undesirable odours, and may also attract pests such as flies or other animals, possibly spreading germs or other bacteria. It should therefore be understood that the shape of the bowl 12 may be significantly altered, once the base 24 has sufficient curvature to retain the above described functionality.

In the embodiment illustrated the bowl 12 is removably secured within the opening 20 of the frame 18. This is advantageous as the bowl 12 may be removed for filling with food, in addition to allowing the bowl 12 to be washed without requiring the entire assembly 10 to be taken out of service. In such a situation, an extra bowl (not shown) may be provided as part of the assembly 10, to be mounted to the support 14 when the original bowl 12 has been removed therefrom, for whatever reasons. Then for example, one of the bowls 12 could be used for feeding solid food to a pet, while the additional bowl (not shown) could then be placed into the support 14 for giving the pet a drink, or a different food from day to day.

The bowl 12 may be secured to the support 14 by any suitable means. In the embodiment illustrated the bowl 12 is provided with a rim 26 about the mouth 16, such that the bowl 12 may be pressed into the opening 20, with the rim 26 then arresting the further advance of the bowl 12 through the opening 20, thereby securing the bowl 12 in the position illustrated in FIG. 1. The bowl 12 is also preferably provided with at least one, and in the embodiment illustrated a plurality of tabs 28 projecting radially outward from the mouth 16. These tabs 28 allow the bowl 12 to be quickly and easily removed from the support 14. The tabs 28 also allow the bowl 12 to be handled without coming into contact with any food contained within or around the bowl 12, thereby improving hygiene.

It will however be appreciated that the bowl 12 need not be releasably engaged to the support 14, and could be formed integrally therewith, or otherwise permanently secured thereto. It will also be appreciated that the support 14 could be provided with a plurality of the openings 20 therein, in order to be capable of carrying two or more of the bowls 12. In particular, the support 14 could be produced symmetrically, such that a second opening (not shown) was provided as a mirror image of the opening 20, on the downstream side of the frame 18.

As described above, the support 14 comprises a number of feet 22 projecting outwardly from the frame 18. These feet 22, and in particular the pair of feet adjacent the opening 20, provide a point on which an animal can stand, thereby applying pressure to the foot 22, and thus clamping the foot 22 against the ground or other surface on which the assembly 10 is located. This will therefore prevent the assembly 10 from moving away from the animal as the animal feeds from the bowl 12. In the preferred embodiment illustrated, each of the feet 22 are provided with a covering shoe 30 which has a high coefficient of friction, in order to further reduce the possibility of unwanted movement of the assembly 10 as an animal feeds therefrom. The shoes 30 are therefore preferably formed from a plastic or rubber or the like. The shoes 30 are also preferably removably secured to the respective foot 22, allowing the shoes 30 to be removed for cleaning or replacement. The feet 22 also allow the assembly 10 to be securely located on an uneven surface such as a lawn or the like.

Referring now to FIGS. 4 and 5, there is illustrated a second embodiment of an animal feeding assembly, generally indicated as 110, again for use in feeding a pet such as a dog or cat. In this second embodiment, like components have been accorded like reference numerals, and unless otherwise stated perform a like function. The assembly 110 provides the same benefits as the assembly 10 of the first embodiment, but is designed not as a free standing unit, but rather to be secured to a substantially upright surface such as a wall or door (not shown) or the like. In addition, the assembly 110 is adapted to carry two bowls (not shown), as will be described in detail hereinafter. For clarity, the bowls (not shown) have been omitted from the drawings, but are each essentially identical to the bowl 12 of the first embodiment.

The assembly 10 thus comprises a support 114 for carrying the pair of bowls, in an orientation such that a mouth of each of the bowls is inclined at an acute angle to the surface from which an animal stands while feeding, for example a kitchen floor or the like. The position at which an animal would stand relative to the assembly 10 is indicated as A on FIGS. 4 and 5. In addition, the angle of inclination of the mouth of each bowl relative to the surface on which an animal stands while feeding, is indicated as B on FIG. 4.

The support 114 comprises a first portion in the form of a back 50 which is adapted to allow the assembly 110 to be secured to an upright surface, as will be described hereinafter in detail. The support 114 further comprises a second portion in the form of a frame 118 projecting outwardly from the back 50, the frame 118 defining a pair of openings 120 therein, for receiving the pair of bowls. As with the bowl 12 of the first embodiment, each bowl (not shown) preferably includes a curved base, and a rim about the mouth, in order to retain each bowl in the respective opening 120. Each bowl also preferably includes a number of tabs, in order to facilitate removal of the bowls from the frame 118. In this second embodiment, the assembly 110 is designed to be secured to a vertical surface, and thus the frame 118 is disposed at an angle to the back 50 such that, when the assembly 110 is secured via the back 50 to a vertical surface, the mouth of each of the bowls is disposed at an angle B of between 1° and 60°, preferably approximately 32.5%.

In order to secure the assembly 110 to a vertical surface such as a wall or door, a coupling 52 is provided on the rear side of the back 50. The coupling 52 may be accessed through a window 60 in the back 50, thereby allowing the coupling 52 to be screwed or otherwise adhered to said vertical surface. The coupling 52 preferably comprises a slideway 54 to be secured to said vertical surface, and a slider 56 slideably mounted to the slideway 54, the slider 56 being secured to the back 50. In this way the coupling 52 will allow the height of the assembly 110, and in particular the pair of bowls, to be varied, thereby allowing the assembly 110 to be tailored to suit the size of the animal feeding therefrom. This function will also allow the bowls (not shown) to be set at a height most convenient or beneficial for digestion. In addition, the raised position of the bowls will be beneficial to the owner, by preventing unnecessary bending while filling or removing the bowls. Furthermore, as the bowls are raised off the ground, cleaning the ground beneath the assembly 10 is simplified, so increasing hygiene.

It is also envisaged that a neck 58 connecting the back 50 to the frame 118 could be provided as a hinge (not shown) or the like, thereby allowing the angle between the frame 118 and the back 50 to be varied, in order to allow the angle B to be correctly set. This would therefore allow the assembly 110 to be secured to a surface which was not vertical, while enabling the correct angular orientation of the bowls to be achieved.

It will be appreciated that the shape and/or configuration of the various components of the system 10, 110 may be significantly varied, once the underlying functionality thereof is retained.

1. An animal feeding assembly comprising a food receptacle; and a support adapted to hold the receptacle at an orientation in which a mouth of the receptacle is disposed at an acute angle to a surface on which, in use, an animal is positioned while feeding from the receptacle, the support comprising a pair of ground contacting feet positioned to be accessible by an animal for the purpose of standing thereon during feeding from the receptacle.

2. An assembly according to claim 1 in which the receptacle has at least a curved base to prevent food from lodging in the receptacle.

3. An assembly according to claim 1 in which the mouth is disposed at an angle of between 1° and 60°.

4. An assembly according to claim 1 in which the receptacle is releasably securable to the support.

5. An assembly according to claim 1 in which the receptacle is substantially hemispherical in shape.

6. A system according to claim 1 in which the support is adapted to hold a pair of the receptacles.

7. (canceled)

8. (canceled)

9. A system according to claim 1 in which at least one of the ground contacting feet is located, in use, upstream of the receptacle with respect to an animal feeding from the receptacle.

10. A system according to claim 1 in which each foot comprises a non slip surface.

11. A system according to claim 1 in which the support defines at least one opening for receiving the at least one receptacle.

12. A system according to claim 1 in which the receptacle comprises a circumferentially disposed rim about the mouth.

13. A system according to claim 1 in which the support comprises a first portion adapted to enable the system to be mounted to a substantially upright surface.

14. A system according to claim 1 in which the support comprises a first portion adapted to enable the system to be mounted to a substantially upright surface such as a wall or the like.

15. A system according to claim 14 in which the receptacle has at least a curved base to prevent food from lodging in the receptacle.

16. A system according to claim 14 in which the mouth is disposed, in use, at an angle of between 1° and 60°.

17. A system according to claim 14, in which the receptacle is releasably securable to the support.

18. A system according to claim 14 in which the receptacle is substantially hemispherical in shape.

19. A system according to claim 14 in which the support is adapted to hold a pair of the receptacles.

20. A system according to claim 14 in which the support comprises a second portion extending from the first portion, to which second portion the at least one receptacle is securable.

21. A system according to claim 20 in which the support comprises a coupling in operative association with the first portion for securing the support to a surface, which coupling is adapted to enable, in use, relative displacement between the coupling and the support.

22. A system according to claim 14 in which the support defines at least one opening for receiving the at least one receptacle.

23. A system according to claim 14 in which the receptacle comprises a circumferentially disposed rim about the mouth.

24. A system according to claim 14 in which the receptacle comprises at least one tab projecting from the mouth.

25. An assembly according to claim 1 in which the mouth is disposed at an angle of between 20° and 40°.

26. An assembly according to claim 1 in which the mouth is disposed at an angle of approximately 32.5°.

27. A system according to claim 1 in which the receptacle comprises at least one tab projecting from the mouth.
